(19) United States
(12) Patent Application Publication
(10) Pub. No.: US 2012/0088644 A1
(43) Pub. Date: Apr. 12, 2012

(54) FLAT PRESSER

(76) Inventor: Michael P. Tarka, Agawam, MA (US)

(21) Appl. No.: 13/252,319

(22) Filed: Oct. 4, 2011

Related U.S. Application Data
(60) Provisional application No. 61/391,318, filed on Oct. 8, 2010.

(51) Int. Cl. B26D 7/18; B26D 7/02; B31B 1/14

(52) U.S. Cl. 493/82; 493/373

(57) ABSTRACT

A flat presser for supporting blanking material during operation of a blanking tool for making packaging blanks includes a plurality of coaxially oriented, concentric wall sections of progressively different interior areas and being collapsible from an extended position wherein the wall sections partially overlap in an axial direction to a collapsed position wherein the wall sections substantially completely overlap in the axial direction, and a biasing mechanism for biasing the wall sections to the extended position.

### CROSS REFERENCE TO RELATED APPLICATIONS

This application claims the benefit of U.S. Provisional Application Ser. No. 61/391,318, filed on Oct. 8, 2010, which is herein incorporated by reference in its entirety.

### FIELD OF THE INVENTION

The present invention relates to a blanking tool for making packaging and carton blanks and, more particularly, to a flat presser for supporting blanking scrap material during operation of the blanking tool.

### BACKGROUND OF THE INVENTION

In the manufacture of cartons during a blanking operation, small sheets of paper material having specific profiles are cut out of larger sheets of paper material. These smaller sheets are known as carton blanks which are later formed into cartons and/or boxes.

As shown in FIGS. 1 and 2, in a die cutting machine 10, the blanks are cut, but not removed from a large sheet 12 of paper material. After the blanks have been cut at a cutting station 14, the large sheet layout 12 is pulled into a stripping station 15, where small pieces of waste in between the blanks are removed, and then to the blanking station 16 where the sheet is positioned over a frame which includes openings which correspond in size, shape and position to the profile of the carton blank layout.

At the blanking station 16, an upper tool is used in combination with the lower frame to knock the carton blanks from the sheet of paper material while holding the scrap material that surrounds the blanks. In particular, as shown in FIG. 3, a male blanker 20 includes a plurality of presser members 22A, 22B, 22C, 22D, 22E secured to a support plate/board 24, and the presser members 22A-22E are dimensioned to be the same shape and slightly smaller than the blanks 26A, 26B, 26C, 26D, 26E of a large sheet 12 supported upon a female blanker 28. Next to and between the presser members 22A-22E are a plurality of prior art standard pressers having presser rails 30. (Only one of the identical six illustrated presser rails in FIG. 3 is identified by the reference number 30 to avoid confusion.) Each prior art flat presser includes two mount housings 32, 34 that secure the presser rail 30 to the support plate 24. Each mount housing 32, 34 includes a guide strut 36, 38 that is secured within the mount housing by a spring biasing mechanism such as a captured coil spring (not shown), and the guide struts 36, 38 are secured to the presser rail 30. The spring biasing mechanism forces the presser rail 30 in a direction away from the support plate 24 and mount housings 32, 34.

As is well known, in operation the support plate 24 is moved against the sheet 12 as shown in FIG. 4 so that the presser rail 30 secures and stabilizes the carton blank scrap surrounding the blanks as the presser members 22A-22E impact the blanks 26A-26E to force them to break apart from the large sheet 12 and move with gravity assistance and guided by stationary joggers (not shown) to blank stacking piles 40A, 40B, 40C, 40D, 40E. After the blanks 26A-26E are removed from the large sheet 12, the sheet is referred to as blanking scrap. As is apparent, the faster the large sheet 12 can be processed by the male and female blankers 20, 28, the more cost efficient the blanking operation becomes.

As discussed above, in order to securely hold the carton blank scrap, known presser rails are interconnected to the support plate 24 by mount housings 32, 34 and guide struts 36, 38. As shown in FIGS. 3 and 4, each guide cylinder 32, 34 biases the presser rail 30 downwardly away from the support plate 24, and are mounted to the support plate 24 such that the mount housings 32, 34 project upwardly from the support plate. 24. However, it is desirable to eliminate any components projecting above the support plate 24 and instead provide interior mounted flat pressers/presser assemblies for a number of reasons. First, for tool storage purposes, an upper tool having interior mounted pressers takes up less space. This is particularly advantageous in locations where storage space is limited. Secondly, many existing die cutting machines are built in such a manner that the upper tool slides into the blanking station of the machine. Any component projecting upwardly from the support plate would interfere with such sliding action. Therefore, only interior mounted flat pressers can be used with such systems.

In addition, during the cutting operation, perimeters of the blanks are cut out using a continuous steel knife configuration of the blank profile. The blanks are usually held in the sheet 12 with nicks. Nicks are small areas around the perimeter where the knife is removed, usually with a small grinding wheel or chisel. Multiple nicks are usually placed around the blanks to carry the sheet into the blanking station 16 where the nicks are pulled apart during the blanking cycle. As the machine speed increases, more nicks may have to be added to the existing cutting tool to help hold the blanks in place. More nicks may hold the sheet together but they can also cause problems when the sheet is transferred to the blanking station 16. Therefore, it is desirable for a machine operator to have the ability to easily add a flat presser to the support plate 24 while the board is still on press. Prior art pressers, however, make it difficult to add pressers onto a support board without cutting a custom profile into the support plate 24 for mounting. In addition, prior art pressers are usually large, not customizable, and there is often insufficient space on the support plate for mounting any additional pressers to increase support and stabilization of the carton blank scrap during the blanking operation. In particular, known presser assemblies are often arranged in static rows, which allow for limited, if any, customization of presser geometry, i.e., the arrangement of pressers on the support plate.

### SUMMARY OF THE INVENTION

In view of the foregoing, it is an object of the present invention to provide a flat presser for supporting blanking scrap material during operation of a blanking tool for making packaging blanks.

It is another object of the present invention to provide a flat presser that is surface mountable with a support board of a blanking tool.

It is another object of the present invention to provide a flat presser that is easy to assembly, inexpensive to manufacture and that utilizes strong materials with low friction.

It is another object of the present invention to provide a flat presser that is easy to mount to standard blanking operation machinery.

It is another object of the present invention to provide a flat presser that provides consistent pressure to the blank scrap throughout the blanking operation.

It is another object of the present invention to provide a flat presser that is small in size and which can be positioned almost anywhere on the support board.

It is another object of the present invention to provide a flat presser that can easily be utilized in combination with a presser rail to provide a linear pressing surface.

In accordance with an embodiment of the present invention, a flat presser includes a plurality of coaxially oriented, concentric wall sections of progressively different interior areas and being collapsible from an extended position wherein the wall sections partially overlap in an axial direction to a collapsed position wherein the wall sections substantially completely overlap in the axial direction, and a biasing mechanism for biasing the wall sections to the extended position.

### BRIEF DESCRIPTION OF THE DRAWINGS

The present invention will be better understood from reading the following description of non-limiting embodiments, with reference to the attached drawings, wherein below:

FIG. 1 is a perspective view of a prior art die cutting machine for manufacturing carton blanks.

FIG. 2 is a schematic illustration of the interior of the prior art die cutting machine of FIG. 1 showing cutting station and a blanking station.

FIG. 3 is a partial perspective view of a prior art male blanker and female blanker cooperatively positioned to knock blanks out of a large sheet of packaging material.

FIG. 4 is a partial perspective view of the FIG. 3 prior art male and female blanker showing usage of a prior art presser rail in knocking out packaging blanks.

FIG. 5 is a perspective view of a flat presser for use with a male blanker of a die cutting machine in accordance the present invention, shown in an extending position.

FIG. 6 is a front elevational view of the flat presser of FIG. 5.

FIG. 7 is a bottom perspective view of the flat presser of FIG. 5.

FIG. 8 is an exploded perspective view of the flat presser of FIG. 5.

FIG. 9 is a perspective view of the flat presser of FIG. 5 shown in a partially collapsed position.

FIG. 10 is a perspective view of the flat presser of FIG. 5 shown in a fully-collapsed position.

FIG. 11 is a bottom perspective view of the flat presser of FIG. 5 in a partially collapsed position.

FIG. 12 is a bottom perspective view of the flat presser of FIG. 5 in a fully-collapsed position.

FIG. 13 is a top plan view of a conical spring for use in the flat presser of FIG. 5.

FIG. 14 is a front elevational view of the conical spring of FIG. 13 illustrating movement of the spring under applied load.

FIG. 15 is a top perspective, exploded view of the flat presser of FIG. 5 illustrating position stops.

FIG. 16 is a bottom perspective, exploded view of the flat presser of FIG. 5 illustrating position stops.

FIG. 17 is a perspective view of a flat presser rail assembly utilizing a plurality of the flat pressers of FIG. 5 and a presser rail in accordance with another embodiment of the present invention.

FIG. 18 is a perspective view of a portion of the flat presser rail assembly of FIG. 17, showing a mounting bracket disconnected from the flat presser.

FIG. 19 is a perspective view of a portion of the flat presser rail assembly of FIG. 17, showing the mounting bracket connected to the flat presser.

FIG. 20 is a perspective, exploded view of the flat presser rail assembly of FIG. 17.

FIG. 21 is a perspective, exploded view of the flat presser rail assembly of FIG. 17 in a partially assembled state.

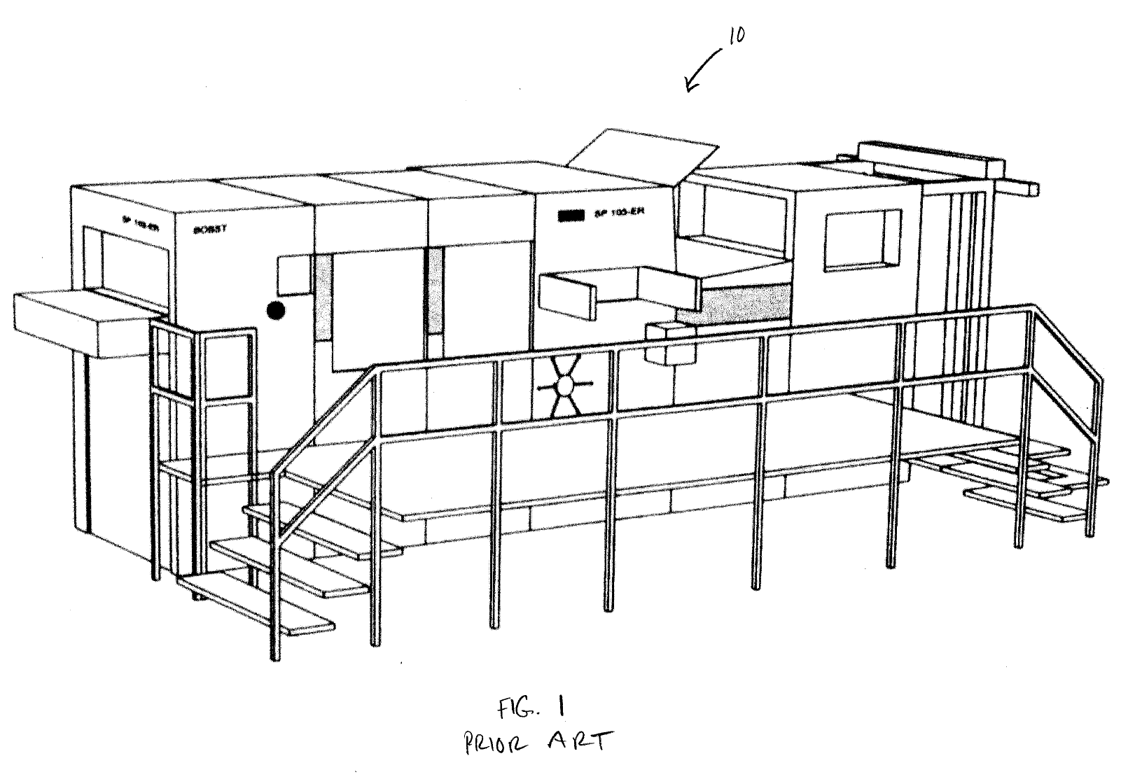

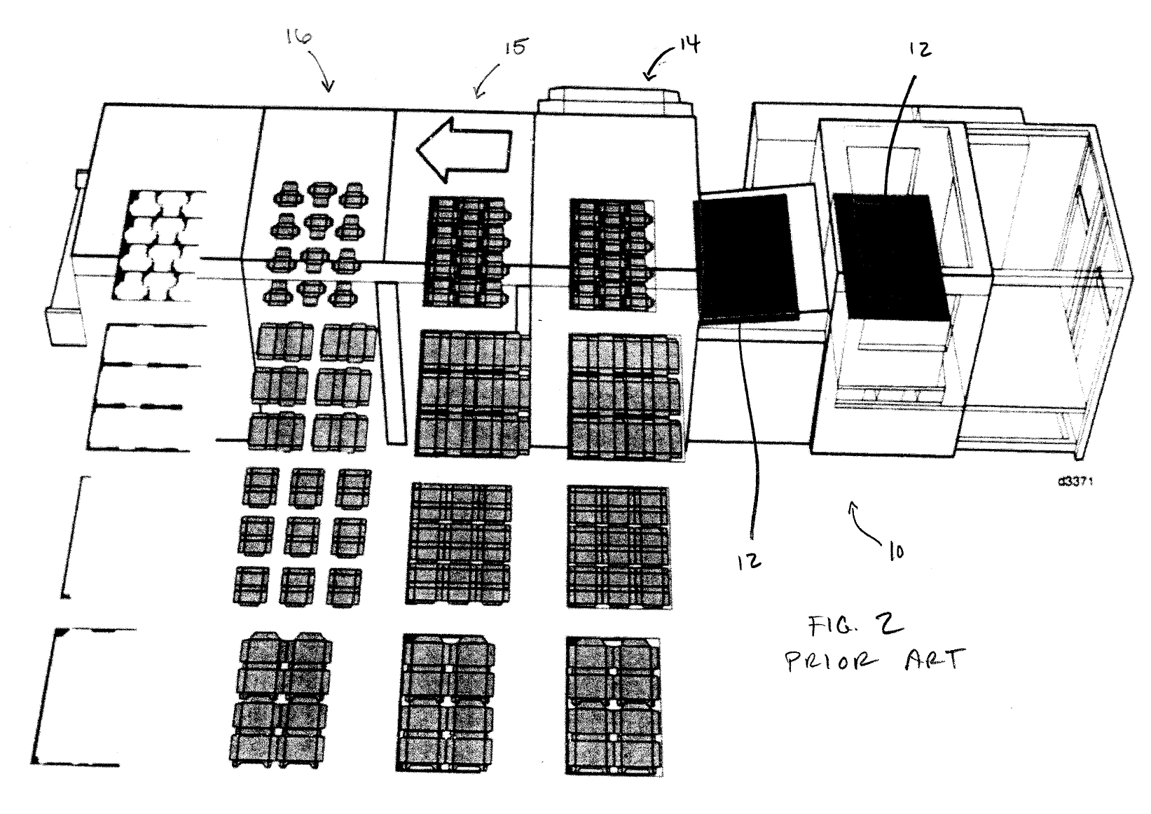

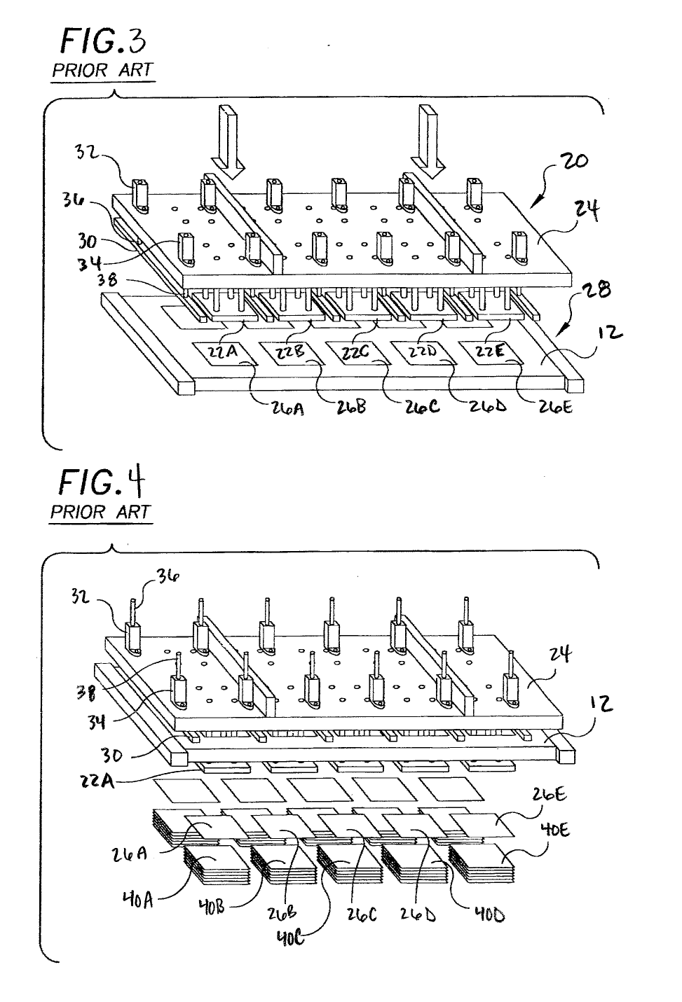

### DETAILED DESCRIPTION OF THE PREFERRED EMBODIMENTS

Referring now to the drawings, FIGS. 5-8 illustrate a flat presser 100 for use with a male blanker of a die cutting machine for converting or processing a sheet of paper material into a carton blank. These machines are well known in the art and are used to cut one or several blanks into each sheet of paper material which, after folding and gluing, may be formed into cartons or boxes. As is conventional, the sheets of paper material within the machine are carried through various sequences of printing, cutting, embossing, creasing, waste stripping and/or blank stations.

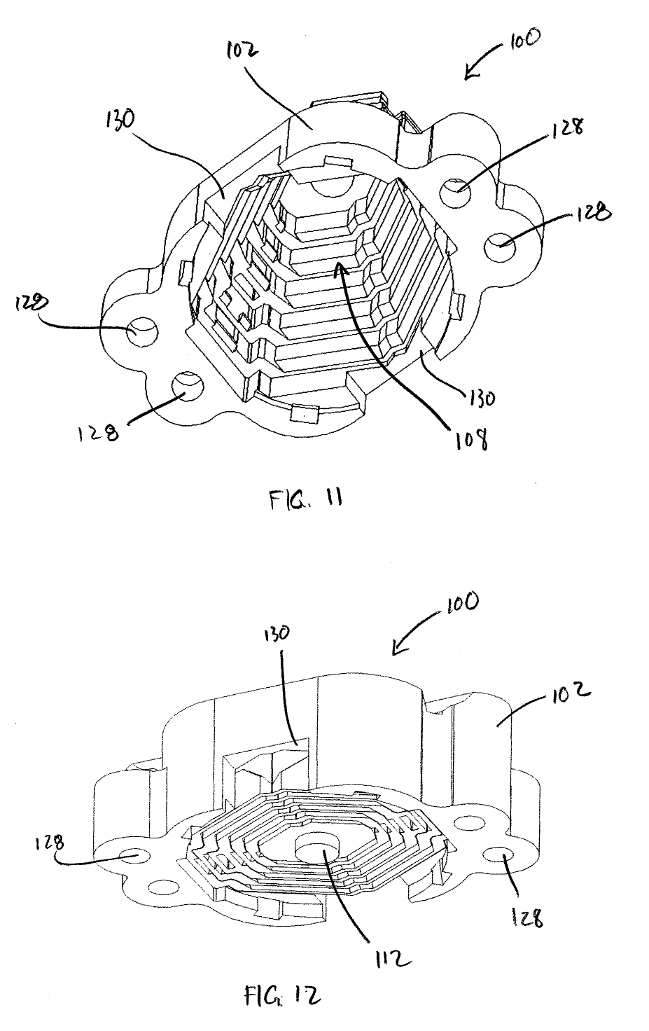

As shown in FIG. 5, the flat presser 100 includes a base 102 and plurality of coaxially oriented, concentric wall sections 104a-f, each wall section generally taking the shape of a rhombus or diamond and having progressively different diagonal lengths (and different inner areas). FIG. 8 shows an exploded view of the flat presser including the base 102 and six wall sections 104a-f, although the invention may include more or fewer wall sections without departing from the broader aspects of the present invention. The wall sections 104a-f are nested within one another and are collapsible from an extended position (FIGS. 5 and 6) wherein the wall sections 104a-f partially overlap in the axial direction to a collapsed position (FIGS. 10 and 12) wherein the walls sections 104a-f substantially completely overlap in the axial direction. FIGS. 9 and 11 illustrates the flat presser 100 in an intermediate, partially collapsed position. As best shown in FIGS. 10 and 12, in the fully collapsed position, the sidewall sections 104a-f are all housed within the diamond shaped opening in the base 102 such that the full height of the flat presser 100 is substantially equal to the height of the base 102. An elastomeric cap 106 having a substantially planar surface is received in the smallest wall section 104a. In the preferred embodiment, the elastomeric cap 106 may be made of rubber or like material having a coefficient of friction high enough to grip and hold the sheet of material during the blanking operation, as discussed in detail below.

As best shown in FIGS. 7 and 11, in the extended position, the flat presser 100 defines a generally open cavity 108 in the bottom thereof. A conical spring 110 is housed within the cavity 108. The conical spring 110 is positioned generally coaxially with the wall sections 104a-f within the cavity 108. The spring 110 is retained in place within the cavity 108 by a locating protrusion 112 formed in the underside of sidewall section 104a that is received by a small diameter end of the spring 110, and by a locking plate 114 secured to the base 102. Importantly, the spring 110 biases the flat presser 100 to its extended position, i.e., it biases wall sections 104a-f away from the base 102 when the spring 110 is retained within the cavity 108. As shown in FIG. 8, locking plate 114 has a plurality of legs that engage complimentary recesses in the base to secure the locking plate 114 to the base. The locking plate 114 may also be secured to the base 102 by other means known in the art, such as by fasteners, adhesive and the like, without departing from the broader aspects of the present invention.

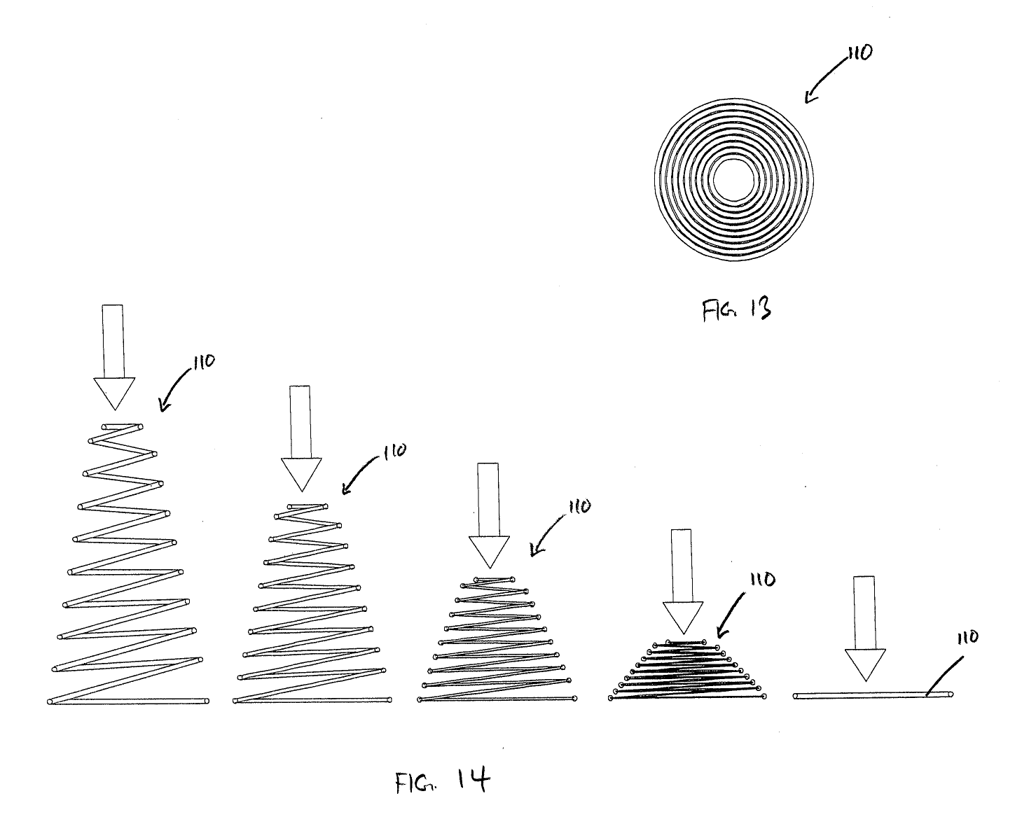

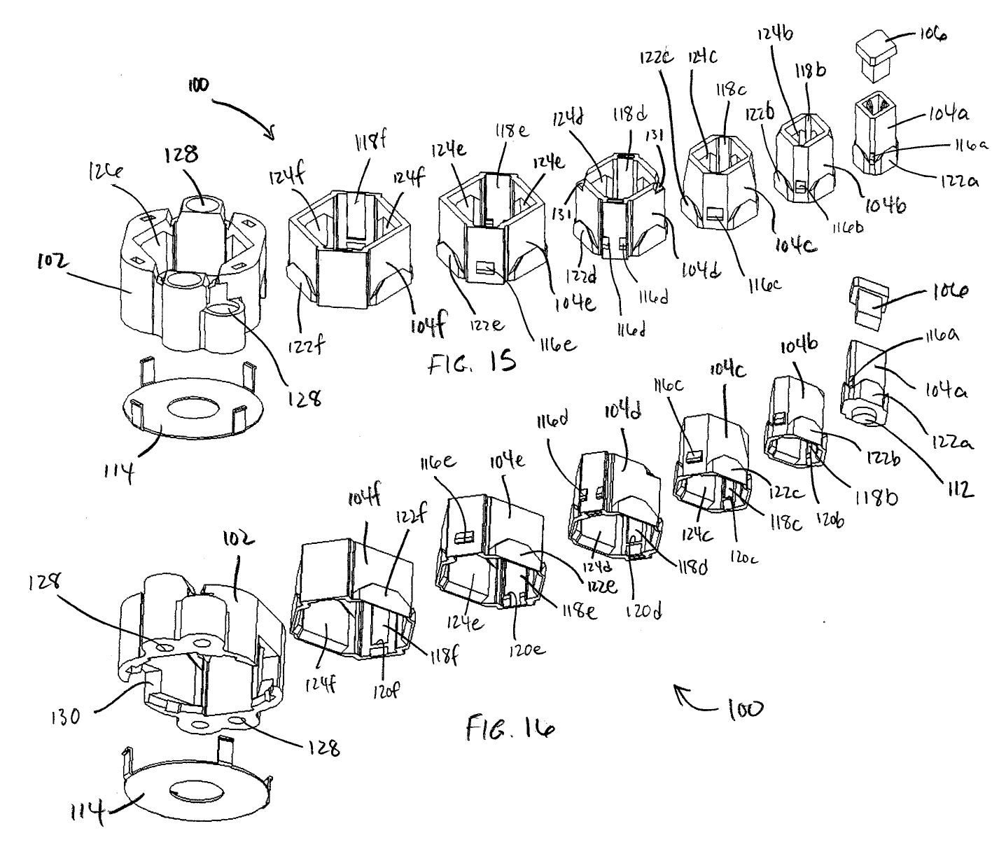

FIGS. 13 and 14 illustrate the configuration of the conical spring 110. As shown therein, the spring has a small diameter end and a large diameter base. As force is applied to the small diameter end of the spring 110, the spring collapses to a substantially flat configuration (see right-most drawing of FIG. 14). This position of the spring 110 corresponds to the fully-collapsed position of the flat presser 100.

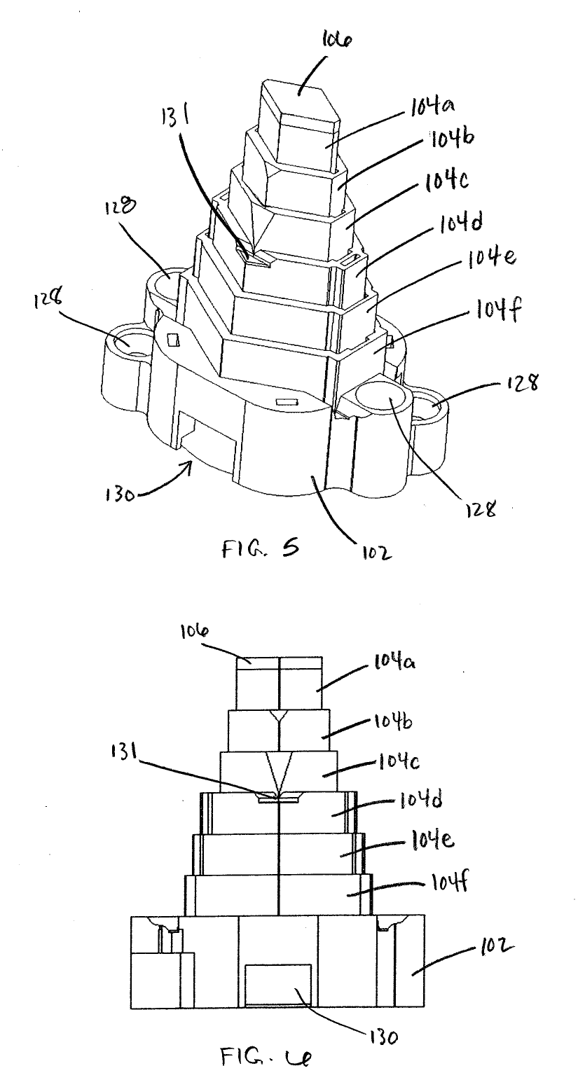

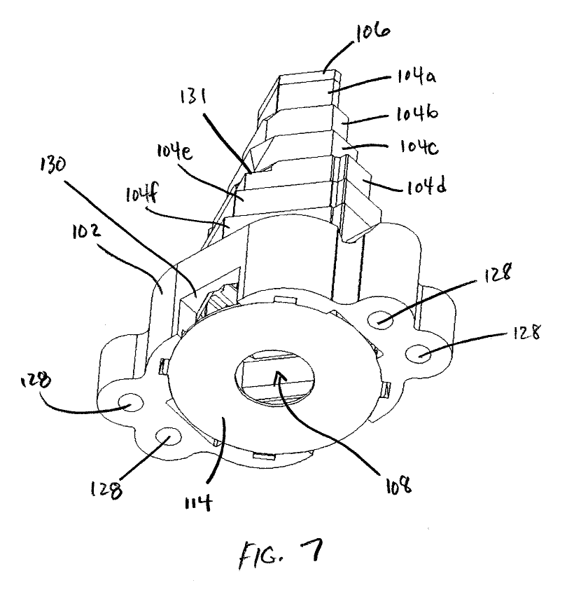

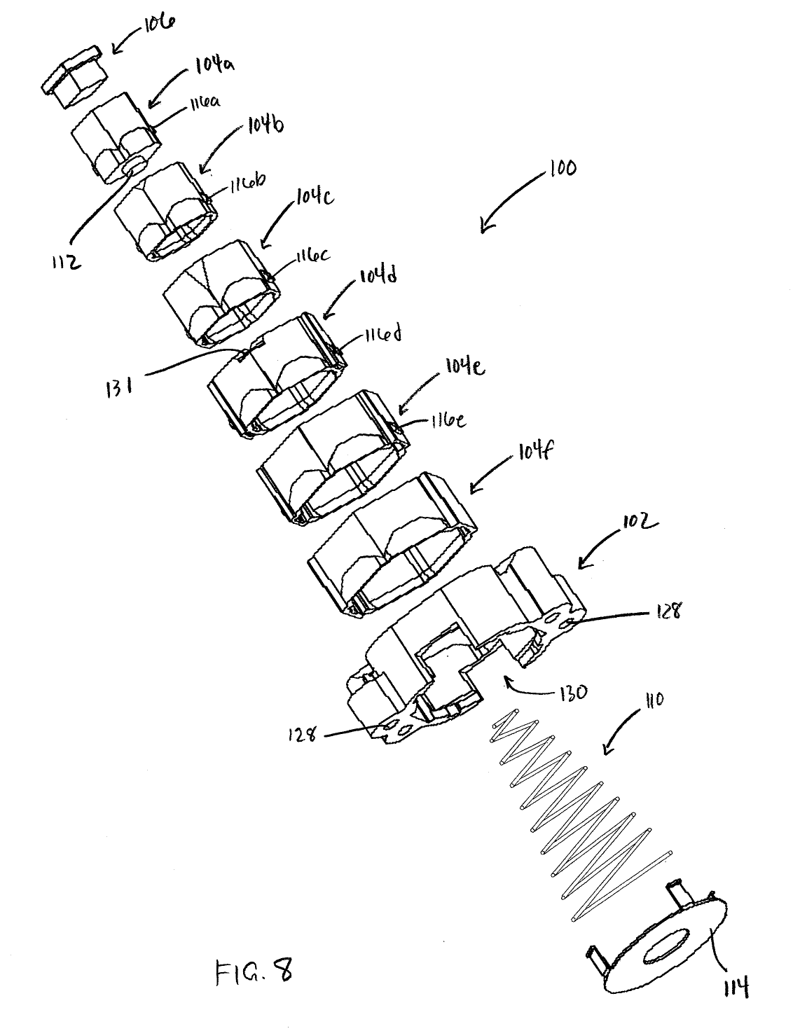

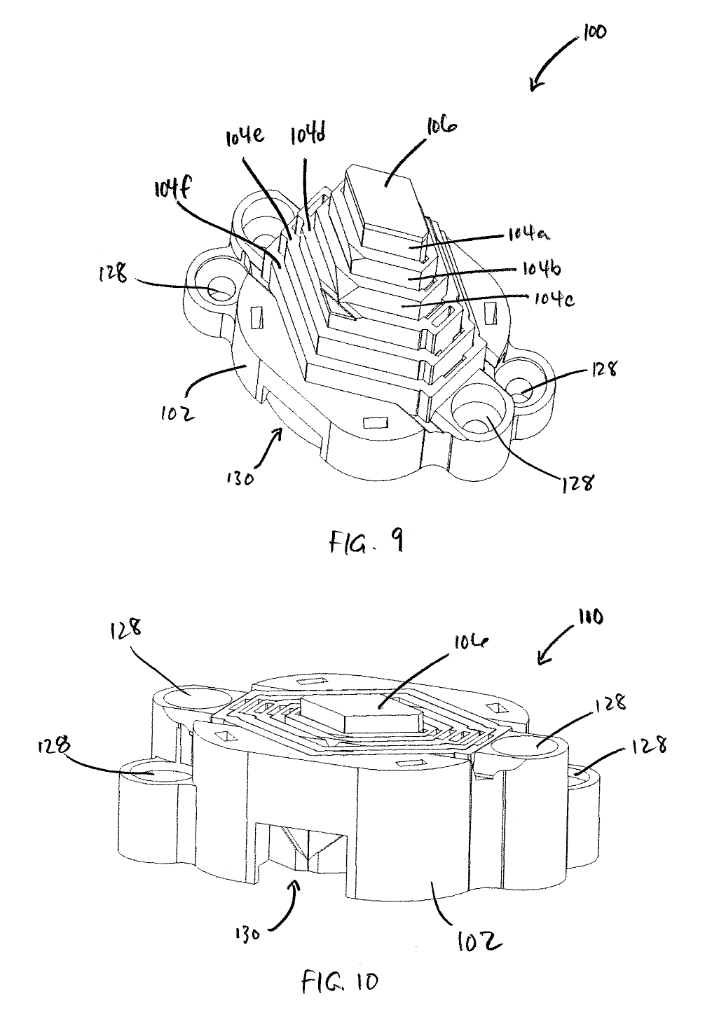

Referring to FIGS. 8, 15 and 16, assembly of the flat presser 100 will now be discussed. During assembly, wall section 104a may first be inserted through the bottom of wall section 104b. Once wall section 104a is nested within wall section 104b, wall section 104b can be nested in the same manner within wall section 104c, and so on. Finally, wall section 104f can be inserted through the bottom of base 102 in a similar manner such that all wall sections 104a-f are in a nested configuration. In this extended configuration, the conical spring 110 may then be inserted into cavity 108 and retained in place by locking plate 114, as discussed above. Elastomeric cap 106 may be inserted into wall section 104a either first, or after the flat presser 100 is assembled. Importantly, locking plate 114 provides a flat surface on the bottom of the flat presser 100, allowing the flat presser 100 to be surface mounted to the bottom of a support board, such as support plate 24 of male blanker 20 of FIGS. 3 and 4.

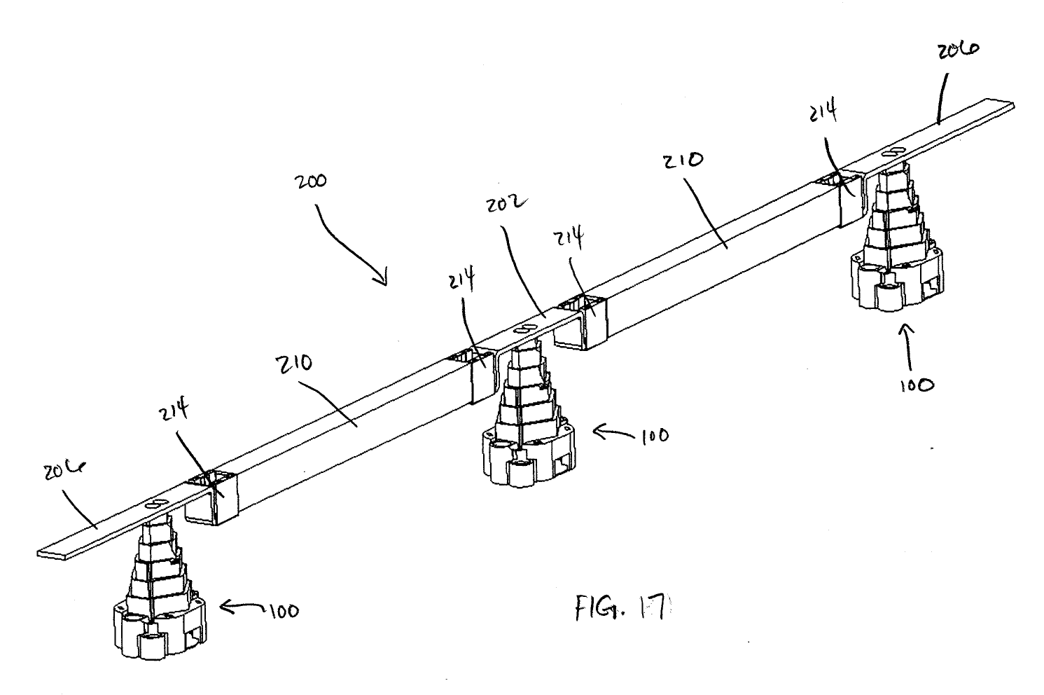

With further reference to FIGS. 15 and 16, the specific configuration of the wall sections 104a-f is shown. As shown therein, wall sections 104a-e each have a pair of protrusions 116a-e on opposing outer walls thereof. The protrusions 116a-e are angled downward and terminate in outwardly extending shoulders (shoulders extend substantially perpendicular from outer walls of wall sections 104a-e). In addition, wall sections 104b-f each have a pair of channels or grooves 118b-f on opposing inner walls thereof. The channels 118b-f are sized to slidingly receive complimentary protrusions 116a-e therein. For example, opposing channels 118b in the inner walls of wall section 104b are sized to slidably receive opposing protrusions 116a of wall section 104a. Likewise, opposing channels 118e in the inner walls of wall section 104e are sized to slidably receive opposing protrusions 116d on wall section 104d.

As further shown in FIGS. 15 and 16, each of the channels 118b-f has an abutment 120b-f adjacent the bottom thereof. Each abutment is sized and positioned so as to be complimentary with the shoulders of protrusions 116a-e on wall sections 104a-e. During assembly, for example, wall section 104a is inserted through the bottom of wall section 104b. The angled portion of the protrusions 116a of wall section 104a permit the protrusions 116a to slide past abutments 120b and into channels 118b such that wall section 104a is received within wall section 104b. Once received, wall section 104a cannot be retracted from wall section 104b because of the abutments 120b on the inner walls of wall section 104b. In particular, any attempt to retract wall section 104a (in a collapsed direction) from wall section 104b causes the shoulder of protrusions 116a to come into contact with abutments 120b. In this respect, downwards movement of wall section 104a with respect to wall section 104b is directly limited by abutments 120b on the inner walls of wall section 104b.

As further shown therein, each wall section 104a-f includes a plurality of raised surfaces 122a-f on the outer walls thereof adjacent the bottom walls thereof. These surfaces 122a-f are complimentary in size and shape to relieved portions 124b-f in the inner walls of wall sections 104b-f. When, for example, wall section 104e is inserted into the bottom of wall section 104f, upward movement of wall section 104e with respect to wall section 104f is limited by the length of relieved portion 122f. In particular, raised surface 122e is slidably received in relieved portion 124f and is limited in its upward travel by the extent of relieved portion 124, i.e., raised surface 122e eventually abuts the end of the relieved portion 124f. As will be readily appreciated, base 102 also has relieved portions 126 on inner walls thereof that are sized and shaped so as to slidably receive raised surfaces 122f of wall section 104f, thereby limiting upwards movement of wall section 104f with respect to the base 102.

Importantly, the contact between the shoulders of protrusions 116a-e with abutments 120b-f prevents each wall section 104a-f from being removed (in a collapsed/retracted direction) from the wall section 104a-f within which it is nested. Likewise, the contact between the raised surfaces 122a-f and the ends of the relieved portions 124b-f, 126 prevents each wall section 104a-f from being removed (in an extended/expanded direction) from the wall section 104a-f (or base 102) within which it is nested.

Referring back to FIGS. 5 and 6, base 102 includes a plurality of mounting throughbores 128. In the preferred embodiment, there are four mounting throughbores in the base 102, although more or fewer throughbores may be utilized without departing from the broader embodiments of the present invention. As will be readily appreciated, the flat presser 100 may be secured to the bottom of a support board of a male blanker, such as support plate 24 of male blanker 20, shown in FIGS. 3 and 4, by screws or the like.

As further shown in FIGS. 5 and 6, the base 102 includes a pair of vent holes 130 in the sidewall thereof, which facilitate smooth operation of the flat presser 100. In particular, during operation, the compression of the conical spring may create a slight pressure differential within the cavity 108 of the flat presser 100 itself, and therefore vent apertures 130 formed in the housing allow for venting and the quick and smooth action of the flat presser 100.

In an embodiment, one or more of the wall sections 104a-f includes a notch 131 or cutout which provides a clearance for the presser members 22A-E in situations where the flat presser 100 may be mounted in close association with the presser members 22A-E.

In the preferred embodiment, the flat presser 100 is approximately 2½ inches tall from base to the tip of the elastomeric member 106 in the fully extended position, and collapses to approximately ⅝ inches tall. In addition, in the preferred embodiment, the flat presser 100 has a major width of approximately 2 inches and a minor width of approximately 1 inch. Moreover, the wall sections 104a-f and the base 102 are preferably formed from a suitably durable material having a suitably low coefficient of friction, such as plastic including, but not limited to, polyethylene and the like.

As will be readily appreciated, the flat presser 100 of the present invention is easy to assemble, inexpensive to manufacture and is formed from lasting materials with a low or very low coefficient of friction. As will be readily appreciated, this provides for a long lasting, lower cost flat presser 100.

With reference to FIGS. 3, 4 and 5, in operation, a plurality of flat pressers 100 are surface mounted to the bottom of a support plate of a blanking tool in predetermined locations (they are utilized in place of presser rails 30 and mount housings 32, 34). Under the bias of the conical spring 110, the flat pressers 100 are each in a fully extended position. As the blanking tool, and thus the support plate (e.g., blanking tool 20 and support plate 24 in FIGS. 3 and 4), move downwardly, flat pressers 100 engage the top surface of the sheet 12 of paper material and retract/collapse, as previously described, to hold the scrap. The presser members 22A-E then push the blanks 26A-E from the sheet 12, and thereafter, the blanking tool 20, including support plate 24 then moves upwardly to its initial starting position where the flat pressers 100 again return to their fully extended positions.

Notably, during downward movement of the blanking tool, it is necessary to securely stabilize the carton blank scrap surrounding the blanks by frictionally holding the scrap with the plurality of flat pressers 100 positioned around the carton blanks throughout the layout. The spring 110 in the flat presser 100 allows for consistent pressure applied to the blank scrap throughout the complete vertical motion of the support board during the blanking cycle.

As discussed above, the utilization of a conical spring that compresses to a completely flat configuration, as shown in FIG. 14, allows the flat presser 100 to fully collapse (see FIG. 10), thereby providing a minimum protrusion distance from the lower surface of the support board 24. Notably, the design of the flat presser 100 allows for quick and easy surface mounting to the underside of the support board 24 using screws or other suitable fastening means. In addition, the small size of the flat presser 100 allows it to be quickly and easily mounted to the support board 24 in almost any location, thereby allowing for a level of customization of presser arrangement heretofore unseen in the art. In particular, as a result of the small size and quick mounting capabilities of the flat presser 100, flat pressers 100 can be quickly and easily mounted at almost any location on the support board 24 by an operator without substantial down-time, thereby providing a precise, pointed stabilization of the sheet of material that is simply not possible with prior art presser devices. In contrast to the present invention, there often will not exist sufficient space on the support board for additional conventional presser assemblies.

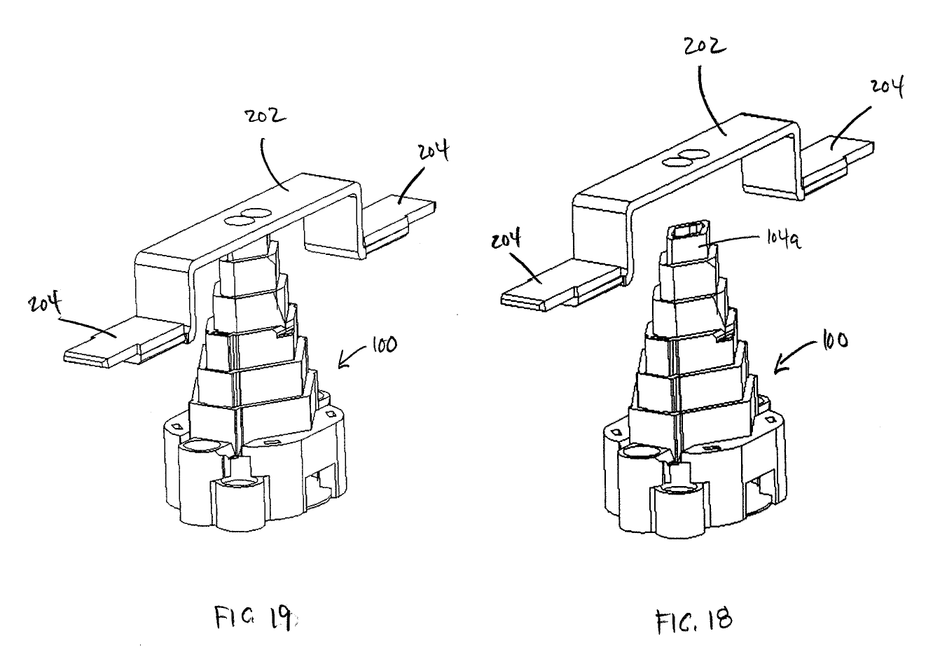

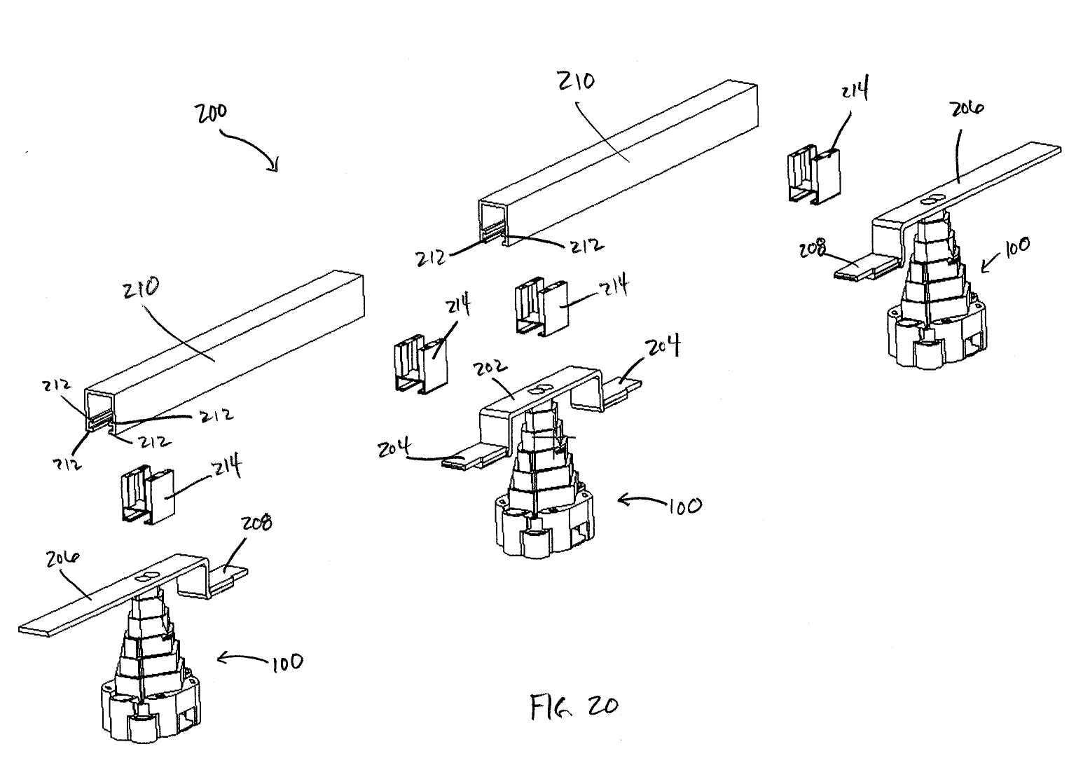

Turning now to FIGS. 17-21, an alternative embodiment of the present invention is shown. As shown therein, in an embodiment, a flat presser rail assembly 200 utilizes flat pressers 100 in combination with presser rails to achieve a pressing arrangement substantially similar to that achieved by the presser rails 30 and mount housings 32, 34 known in the art, but which also provides the advantages hereinbefore disclosed.

With specific reference to FIG. 17, the flat presser rail assembly 200 includes a plurality of flat pressers 100 with the elastomeric cap 106 not included or removed. In the preferred embodiment, the assembly 200 utilizes three linearly spaced flat pressers 100. A center rail mounting bracket 202 is secured to the distal end of wall section 104a of the middle flat presser 100. The center rail mounting bracket 202 is generally U-shaped and has a plurality of outwardly extending arms 204, as best shown in FIGS. 18-20. Similarly, end rail mounting brackets 206 are secured to the distal ends of walls sections 104a of the respective end flat pressers 100. The rail mounting brackets 206 are generally L-shaped and have an arm 208 extending towards the middle flat presser 100. The rail mounting brackets 202, 206 may be attached to the respective flat pressers 100 by means known in the art, such as by fasters and the like. In an embodiment, the mounting brackets 202, 206 may be secured to the flat pressers 100 by means similar to how the elastomeric cap 106 is secured, i.e., friction fit.

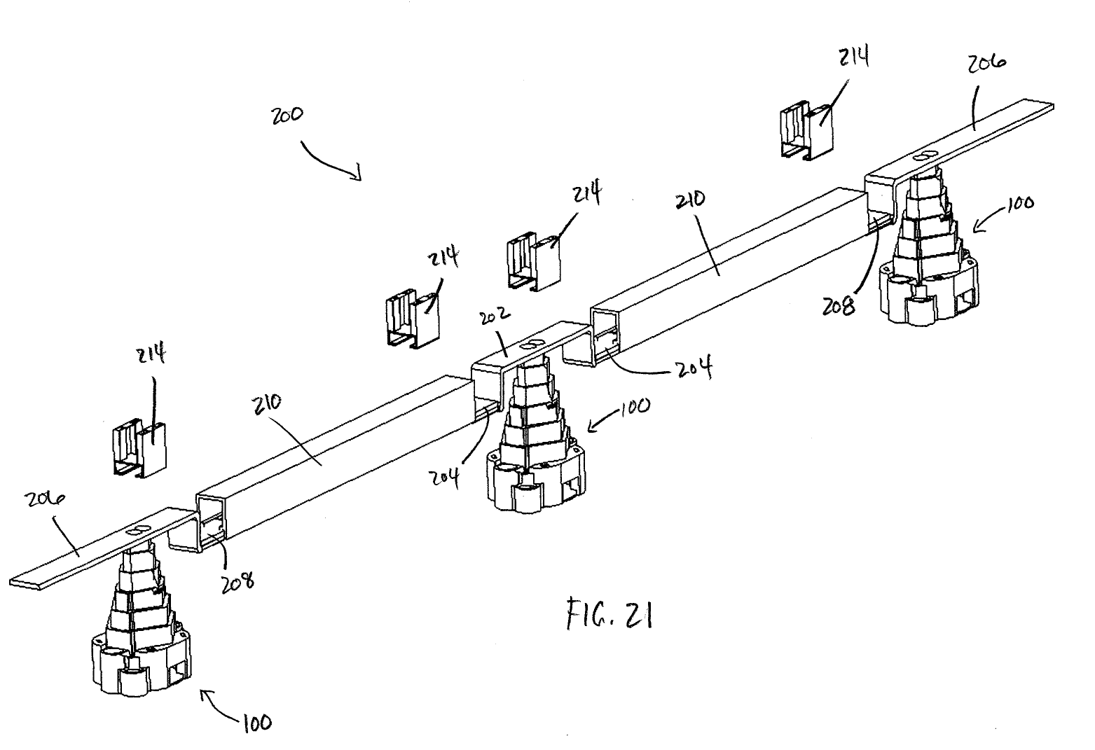

As best shown in FIGS. 20 and 21, the flat presser rail assembly 200 further includes presser rail sections 210. The presser rail sections 210 are preferably formed from a durable material such as extruded aluminum or the like, although other materials are certainly possible without departing from the broader aspects of the present invention. The presser rails 210 each include a pair of guide rails 212 defining a channel therebetween for slidably receiving arms 204, 208 of the mounting brackets 202, 206. FIG. 21 illustrates the arms 204, 208 received in presser rails 210. A plurality of retaining clips 214 are also included and enclose the remaining space between the presser rails 210 and the mounting brackets 202, 206. As shown therein, the retaining clips 214 snap over a portion of the arms 204, 208 of the mounting brackets 202, 206. Referring back to FIG. 17, the presser rails 210 and the mounting brackets 202, 206 form a generally planar presser surface. As with the flat pressers 100 discussed above, presser assembly 200 may be flush mounted to the underside of a support board of a male blanking tool by screws or other means known in the art.

In operation, the flat presser rail assembly 200 is surface mounted to the bottom of a support plate, such as support plate 24 shown in FIGS. 3 and 4 in a predetermined location. Under the bias of the conical spring 110, the flat pressers 100, and thus the presser rails 210, are in an extended position away from the under surface of the support board 24. As the blanking tool 20, and thus the support plate move downwardly, the planar surface of the presser assembly 200 defined by the presser rails and the mounting brackets 202, 206 engage the top surface of the sheet 12 of paper material and the flat pressers 100 retract/collapse in the manner described above. The presser members 22A-E then push the blanks 26A-E from the sheet 12, and thereafter, the blanking tool 20, including support plate 24 then moves upwardly to its initial starting position wherein the flat pressers 100, and thus the flat presser rail assembly 200, again return to their fully extended positions.

In an embodiment, a shorter flat presser rail assembly may be constructed using two end flat pressers. Similarly, a longer presser rail may be constructed using two middle and two end flat pressers. Indeed, as will be readily appreciated, a flat presser rail assembly of almost any size may be constructed by using any number of flat pressers 100 and any combination of mounting brackets and presser rails, without departing from the broader aspects of the present invention.

In an embodiment, multiple presser assemblies 200 may be surface mounted to the bottom of the support board. In yet another embodiment, individual flat pressers 100 may be utilized in combination with one or more flat presser rail assemblies 200 to provide an even more tailored support and stabilization system for the sheet of material. In particular, additional flat pressers 100 may be added to the support board 24 to more specifically tailor the presser arrangement to the specific geometry of the carton/packaging blanks.

Although this invention has been shown and described with respect to the detailed embodiments thereof, it will be understood by those of skill in the art that various changes may be made and equivalents may be substituted for elements thereof without departing from the scope of the invention. Particularly, the present invention is not limited to a particular structure and arrangement of the slide components surrounding the extractor mechanism.

In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A flat presser for supporting blanking material during operation of a blanking tool for making packaging blanks, said flat presser comprising:
a plurality of coaxially oriented, concentric wall sections of progressively different interior areas, said wall sections being collapsible from an extended position wherein said wall sections partially overlap in an axial direction to a collapsed position wherein said wall sections substantially completely overlap in said axial direction; and
a biasing mechanism for biasing said wall sections to said extended position.

2. The flat presser of claim 1, further comprising:
an elastomeric cap secured to one of said wall sections and defining a distal end of said flat presser.

3. The flat presser of claim 1, wherein:
said wall sections which are adjacent to each other have substantially similar geometric shapes.

4. The flat presser of claim 1, wherein:
said biasing mechanism is a conical spring, said conical spring being disposed in a cavity defined by said wall sections when in said extended position.

5. The flat presser of claim 4, further comprising:
a locating protrusion for locating said conical spring within said cavity; and
a locking plate for retaining said conical spring within said cavity.

6. The flat presser of claim 1, wherein:
at least one of said wall sections has a protrusion extending from an outer wall thereof, said protrusion including a shoulder;
at least another one of said wall sections has a channel formed in an interior wall thereof for slidably receiving said protrusion, said channel terminating in a first abutment surface; and
wherein said shoulder abuts said first abutment surface when said wall sections are moved to said collapsed position in a first direction to limit over-travel of said wall section in said first direction.

7. The flat presser of claim 6, wherein:
at least one of said wall sections has a raised surface formed on an outer wall thereof;
at least another one of said wall sections has a relieved area formed in an interior wall thereof, said relieved area being dimensioned to slidably receive said raised surface and terminating in a second abutment surface; and
wherein when said wall sections are moved in a second direction opposite said first direction to said extended position, said raised surface abuts said second abutment surface to limit over-travel of said wall section in said second direction.

8. The flat presser of claim 1, further comprising:
a base member, said base member being dimensioned to receive said wall sections in a nested configuration;
wherein said base member includes at least one vent aperture formed in a sidewall thereof.

9. A flat presser rail assembly, comprising:
a plurality of flat pressers, each said flat presser including a plurality of coaxially oriented, concentric wall sections of progressively different interior areas, said wall sections being collapsible from an extended position wherein said wall sections partially overlap in an axial direction to a collapsed position wherein said wall sections substantially completely overlap in said axial direction, and a biasing mechanism for biasing said wall sections to said extended position; and
at least one presser rail operatively connected to at least two of said plurality of flat pressers and defining a generally planar pressing surface for contacting and securing a sheet of material during a blanking operation of a blanking tool.

10. The flat presser rail assembly of claim 9, further comprising:
a mounting bracket secured to a distal end of each of said flat pressers, said mounting brackets including at least one arm; and
wherein said at least one presser rail includes a channel for slidably receiving said arm of said mounting brackets; and
wherein at least a portion of said mounting brackets and a surface of said at least one presser rail define said planar pressing surface.

11. The flat presser rail assembly of claim 9, wherein:
said at least one presser rail is formed from an extruded metal.

12. The flat presser rail assembly of claim 9, wherein:
said plurality of flat pressers is three flat pressers including a middle flat presser and a pair of opposing end flat pressers; and
said at least one presser rail is two presser rails, one of said two presser rails being operatively connected to one of said opposing end flat pressers and said middle flat presser and the other of said two presser rails being operatively connected to the other of said opposing end flat pressers and said middle flat presser.

13. The flat presser rail assembly of claim 9, wherein:
said biasing mechanism is a conical spring, said conical spring being disposed in a cavity defined by said wall sections when in said extended position.

14. The flat presser rail assembly of claim 9, wherein:
said wall sections which are adjacent to each other have substantially similar geometric shapes.

15. The flat presser rail assembly of claim 10, further comprising:
at retaining clip connected to said mounting bracket adjacent said presser rail.

16. A blanking tool for making packaging blanks from a sheet of material, said blanking tool comprising:
a female blanker for supporting said sheet of material; and
a male blanker having a plurality of presser members secured to a support plate, said male blanker disposed generally above said female blanker and movable towards and away said female blanker to knock said packaging blanks from said sheet, said male blanker further including a plurality of flat pressers surface mounted to an underside of said support plate and configured to secure said sheet as said presser members impact said packaging blanks.

17. The blanking tool of claim 16, wherein:
said flat pressers each include a plurality of coaxially oriented, concentric wall sections of progressively smaller size nested within one another, said wall sections being collapsible from an extended position wherein said wall sections partially overlap in an axial direction to a collapsed position wherein said wall sections substantially completely overlap in said axial direction; and
a biasing mechanism for biasing said wall sections to said extended position.

18. The blanking tool of claim 17, further comprising:
an elastomeric member secured to one of said wall sections and defining a distal end of said flat presser, said elastomeric member contacting said sheet as said presser members impact said packaging blanks.

19. The blanking tool of claim 16, wherein:
said biasing mechanism is a conical spring, said conical spring being disposed in a cavity defined by said wall sections when in said extended position.

20. The blanking tool of claim 16, wherein:
said flat pressers include a base member, said base member being dimensioned to receive said wall sections in a nested configuration, said base member including at least one vent aperture formed in a sidewall thereof adjacent said support plate.
